(19) United States
(12) Patent Application Publication
(10) Pub. No.: US 2017/0126985 A1
(43) Pub. Date: May 4, 2017

(54) Enumeration of Cameras in an Array

(71) Applicant: GoPro, Inc., San Mateo, CA (US)

(72) Inventors: William D. Orner, Mountain View, CA (US); Alexander O'Donnell, Alameda, CA (US)

(21) Appl. No.: 14/927,466

(22) Filed: Oct. 30, 2015

(51) Int. Cl. H04N 5/247; H04N 5/232

(52) U.S. Cl. CPC H04N 5/247; H04N 5/23238

(57) ABSTRACT

Disclosed is an apparatus and method for an enumeration circuit that enumerates a plurality of devices in an array. The apparatus includes an input line to receive an input signal. A comparator compares the voltage of the input signal to a voltage of a ground reference. Based on the comparison, a first device detector module determines if the current device is a first device of the plurality of devices. The first device detector module asserts a first camera signal if the current device is a first device, else de-asserts the signal. A serial decoder module decodes the input signal based on the first camera signal. An identification number generator module generates an identification string for the current device based on the decoded input signal and the first camera signal. The identification string is encoded by a serial encoder and is driven to the output line by a line driver.

### BACKGROUND

Field of Art

The disclosure generally relates to the field of camera arrays, and more particularly, a method for enumeration of cameras in an array.

Description of Art

Multiple cameras are mounted in an array to capture a panoramic or a multi-dimensional view of an area. Typically, each camera in the array captures a single image. Images from each camera are then stitched together to form the panoramic or multi-dimensional view. The stitching of the images is typically performed by a post-processor. To stitch the images correctly, the post processor must have the position information of each camera in the array. An identification number can indicate the position of the camera during an image capture.

Typically, the identification numbers are assigned manually to each camera. This method is highly prone to errors and subsequently may lead to incorrect stitching of the images. Additionally, replacement of a camera requires re-assignment of the identification number.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 an example embodiment of an array of cameras connected in a daisy chain for enumeration.

FIG. 2 illustrates an example embodiment of an enumeration circuit connected to each camera in the daisy chain.

FIG. 3 illustrates an exemplary enumeration of each camera of an array of cameras arranged in a circular configuration.

FIG. 4 illustrates an exemplary enumeration of each camera of an array of cameras arranged in a cubical configuration.

FIG. 5 illustrates a flowchart for a method of enumerating each camera in an array of cameras connected in a daisy chain, according to an example embodiment.

FIG. 6 illustrates an exemplary camera architecture for use with the array of cameras.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Configuration

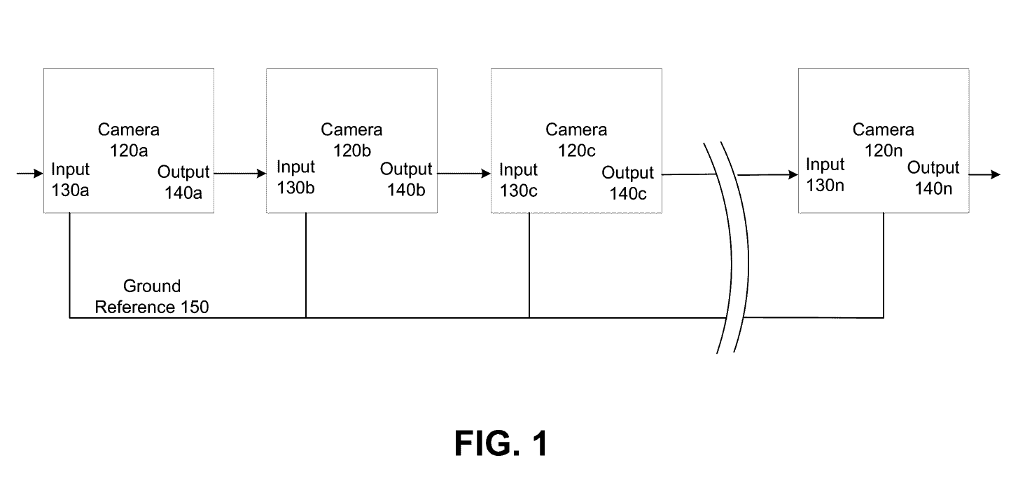

FIG. 1 an example embodiment of an array of cameras 120a-n (generally 120) coupled in a daisy chain for enumeration. The array of cameras (120a-n) can be a predetermined number of cameras, N (or n), e.g., 2, 3, 4, 6, or 12. The daisy chain utilizes a single wire data 130, 140 and a ground reference 150 connection to each camera 120. The cameras are wired together in a sequence or in a ring. Each camera 120 has an input line 130a-n (generally 130 and an output line 140a-n (generally 140). In a daisy chain, the output line 140 of a first camera (e.g. 120a) is connected to the input line 130 of the next camera (e.g. 120b). The input line 130 and output line 140 are used as single wired data line.

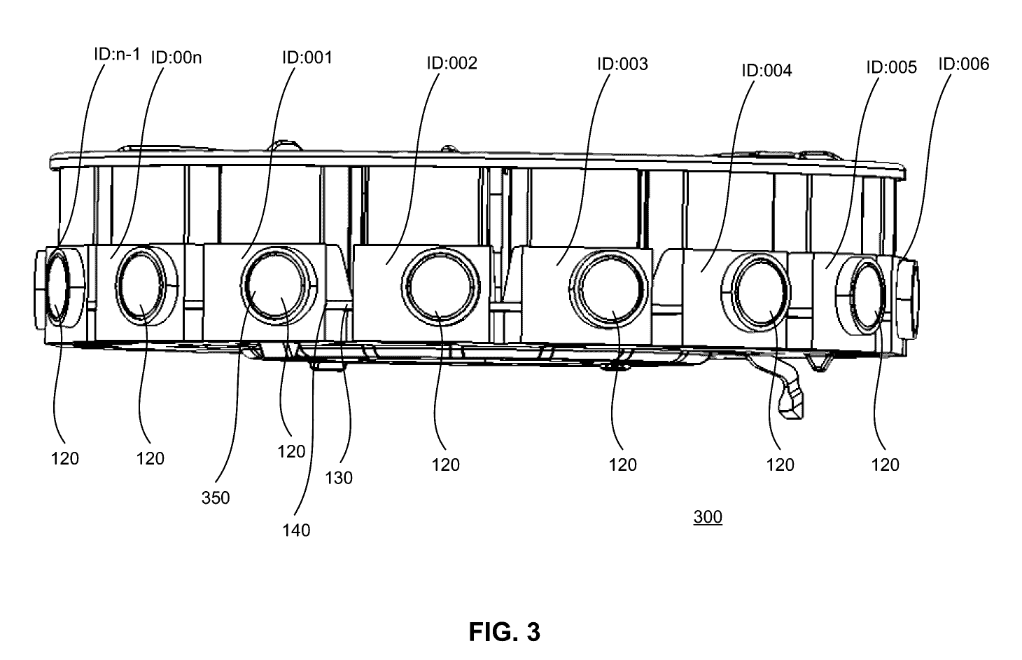

The array of cameras 120 may be mounted on camera mounting structures that are capable of holding the N number of cameras. For example, in one embodiment, the camera mounting structure may have a substantially circular configuration 300 as shown in FIG. 3. The circular configuration of cameras may hold N cameras and provide an image capture in a panoramic field. For example, N can be 3 cameras 120 or 6 cameras 120 or N can be 12 cameras 120. Each field of view provides for capture of an equal quality of a field of view. Each camera 120 is positioned within the circular camera mounting structure 300 such that the lens of the camera 120 fits into the lens opening 350.

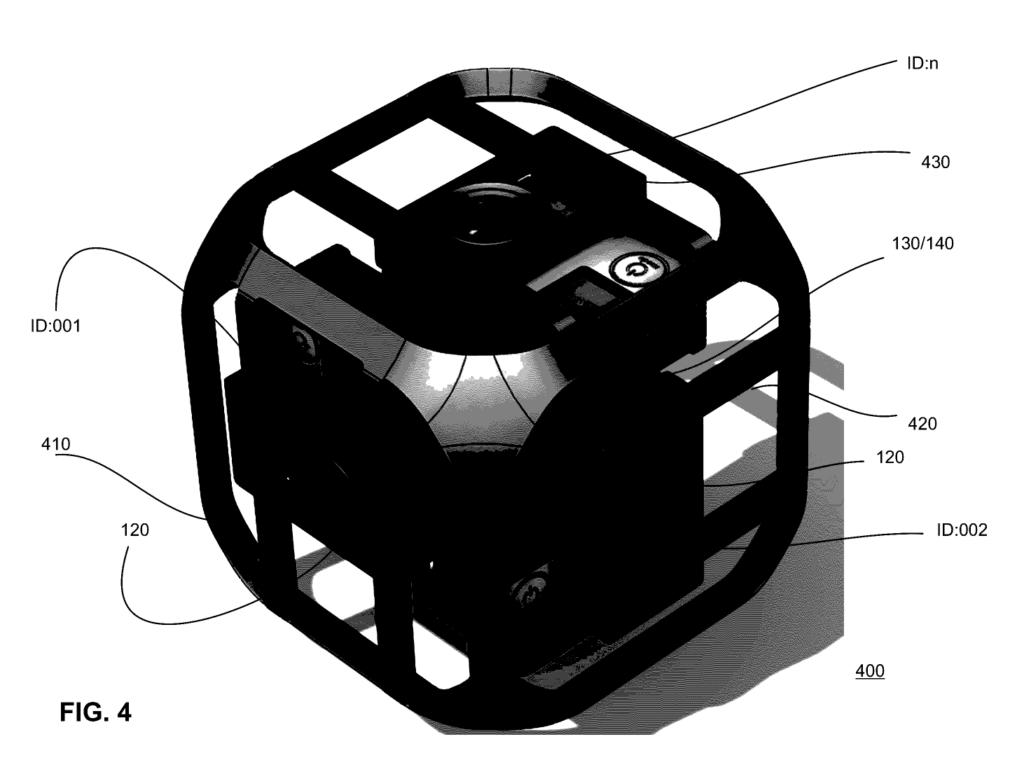

In another embodiment, the cubic cage structure 400 shown in FIG. 4 may hold N cameras, where the N cameras provide an image capture in field of, for example, 4 pi steradias. For example, N can be 3 cameras 120 or 6 cameras 120 or N can be 12 cameras 120. Each field of view provides for capture of an equal quality of a field of view.

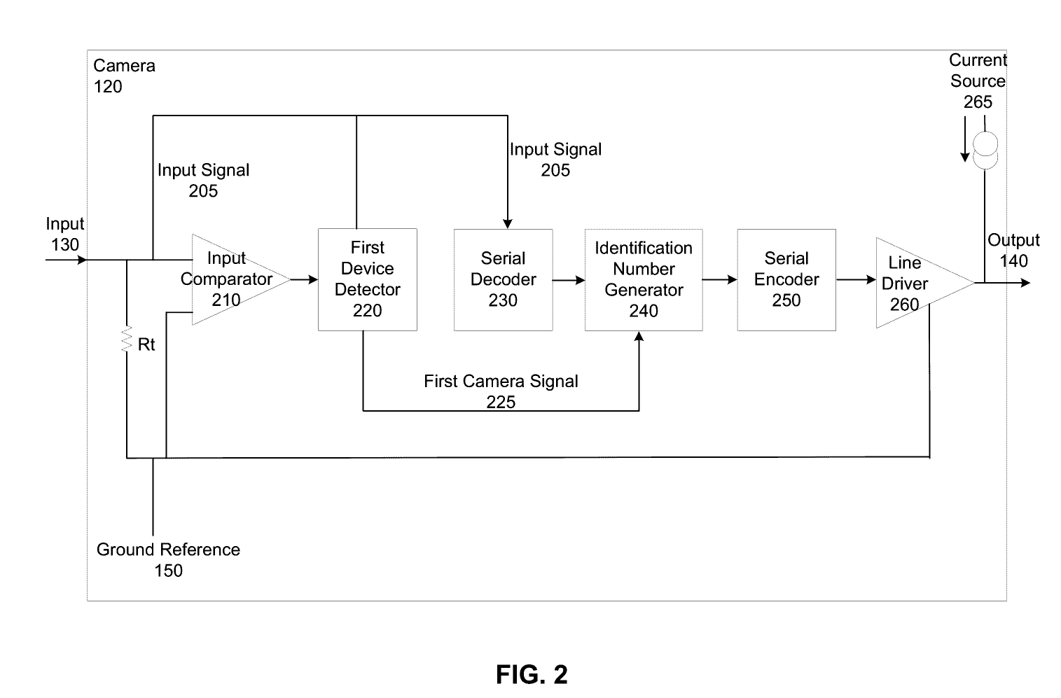

FIG. 2 illustrates an example embodiment of an enumeration circuit connected to each camera in the daisy chain. The enumeration circuit may be a part of the camera device 120 or may be connected externally to the camera 120. The enumeration circuit is primarily used for assigning an identification to the camera 120 so that the images captured by each camera 120 can be stitched correctly to provide an appropriate image capture view, for example a panoramic view, 4 pi steridian view, a spherical view or any other such image capture view.

The enumeration circuit includes an input comparator 210, a first device detector 220, a serial decoder 230, an identification number generator 240, a serial encoder 250, a line driver 260, and a current source 265. The input comparator 210 couples to an input line 130 and a ground reference 150. The input line 130 of the camera 120 may be connected to a previous camera 120 that has been enumerated. Alternatively, the input line 130 may not be connected to a previous camera as it may be the first device to be enumerated.

An input signal 205 is received on the input line. The input signal 205 is at a specific voltage level with respect to the ground reference 150. The voltage level of the input signal 205 depends on whether the input line 130 is connected to a current source 265 from a previous output line 140 or not.

One end of a resistor Rt is connected in series with the input line 130, the other end of the resistor Rt is connected to the ground reference 150. The resistor Rt may cause the input signal 205 to be at or close to the voltage level of the ground reference 150 when there is no current source on the input line 130. In case the input line 130 is connected to a current source 265 of a previous device there is current at the input signal 205, the resistor Rt may cause the input signal to be at a voltage level above the ground reference voltage level.

The input comparator 210 compares the voltage level of the input signal 205 to the voltage level of the ground reference 150. The output of the input comparator is coupled to the input of the first device detector 220.

The first device detector 220 receives an output signal from the input comparator 210 that indicates if the input signal 205 and the ground reference 150 are at the same voltage level or a different voltage level. If the voltage level of the input signal 205 is above the ground reference voltage level 150, it indicates that there is an incoming current from the output line 140 of a previous camera 120. If the voltage level of the input signal 205 is at or close to the ground reference level 150, it indicates that there is no incoming current from the output line 140 of the previous camera 120 and thus the current device is the first camera 120 to be enumerated. The first device detector 220 asserts a first camera signal 225 if the current camera is the first camera; else the first camera signal 225 is de-asserted. The first camera signal 225 is sent to the identification number generator 240.

The input signal 205 is further propagated to a serial decoder 230. The serial decoder 230 decodes the input signal 205 to recover data that indicates the identification number of the previous camera 120. The serial decoder 230 decodes a valid identification number only if the camera is not a first camera 120. The decoded signal is sent to the identification number generator 240 that is coupled to the output of the serial decoder 230.

The identification number generator 240 receives the first camera signal 225 and the decoded input signal, and based on the two signals it generates an identification string for the camera 120. The identification string includes an identification number and optionally may include strings or alphanumeric characters. When the first camera signal 225 is asserted, an identification string is generated to indicate a first camera 120, for example, ID=001 in FIG. 3. When the first camera signal 225 is de-asserted, the identification string is generated after receiving the decoded input signal. The identification string is generated based on an algorithm that uses the decoded input signal which is the identification string of the previous camera. For example, if the decoded input signal is ID=001, the algorithm may be as simple as incrementing the previous camera identification string by 1, hence the current camera identification string will be ID=002. Alternatively, a different algorithm may be used to generate the current camera identification string.

The generated identification string is received by the serial encoder 250 and converted into a serial coded format. The serial encoding may utilize Manchester encoding, alternatively other encoding methods may be used.

The serially encoded identification string is sent to the next camera 120 via the output line 140 driven by a line driver 260. The line driver 260 includes a constant current source 265 that maintains a continuous voltage level on the output line 140 when the line driver is not sending data. The line driver 260 transmits the electrical signal (i.e. the serially encoded identification string) to the output line 140 and onto the next camera 120.

FIG. 3 illustrates an exemplary enumeration of each camera of an array of cameras 120 arranged in a camera mounting structure 300 that has a substantially circular configuration. Each camera 120 in the array captures an image or a video, and the images are stitched together to achieve a single composite image. The circular camera mounting structure 300 may hold up to N number of cameras and can capture an image in a panoramic field, e.g., a 360 degree view of an area.

Each camera may capture an image at one of the 360 degree angle in the area and each image may have a different view of the area. In order to provide a correct 360 degree or a panoramic image, the images must be stitched correctly, i.e., in the order that they were captured. To ensure the correct order and position of the cameras, the cameras are enumerated. FIG. 3 shows an exemplary enumeration of the N cameras in the array, e.g., ID=001, ID=002, . . . ID=n−1, ID=n. The cameras are connected in a daisy chain for the purpose of enumeration, i.e., the input 130 of a camera is connected to the output 140 of the next camera, as shown between the camera with ID=001 and camera with ID=002.

Illustrating an example for capturing a panoramic image with the circular configuration of the array of cameras, the camera with ID=001 may be at a reference angle (0 degrees) for capturing the image. The camera with ID=002 may capture the view of the area at an angle of 20 degrees from the reference angle (0 degrees). Similarly, the other cameras may capture an image at an angle of 40 degrees, 60 degrees, 80 degrees, etc. from the reference angle. An ideal panoramic view of the area can be obtained if these images are stitched in the correct order, i.e. the image from the camera ID=001 must be stitched with the image from the camera ID=002 which is further stitched with the image from the camera ID=003 and the daisy chain continues till the images from the camera ID=00n is stitched together.

FIG. 4 illustrates an exemplary enumeration of each camera of an array of cameras arranged in a camera mounting structure 400 that has a cubical configuration. Each camera 120 in the array captures an image or a video, and the images are stitched together to achieve a single composite image. The cubical camera mounting structure 400 may hold up to N number of cameras and can capture an image in a 4 pi steradias field, e.g. a three dimensional (3D) spherical view of an area.

In the cubical configuration, one or more cameras may be mounted on one of the six surfaces of the cubical structure. One or more cameras may capture an image of one of the steradian of the area, i.e. a conical area of a spherical view. In order to provide a correct 4 pi steradias view a 3D spherical image, the images must be stitched correctly, i.e. in the order that they were captured. To ensure the correct order and position of the cameras, the cameras are enumerated. FIG. 4 shows an exemplary enumeration of the N cameras in the cubical configuration, e.g., ID=001 on surface 410, ID=002 on surface 420, . . . , ID=n on surface 430. In case there are multiple cameras on a single surface, the cameras on that surface are enumerated before continuing to the next surface that may have multiple cameras mounted as well. The cameras are connected in a daisy chain for the purpose of enumeration, i.e., the input 130 of a camera is connected to the output 140 of the next camera, as shown between the camera with ID=002 and camera with ID=003.

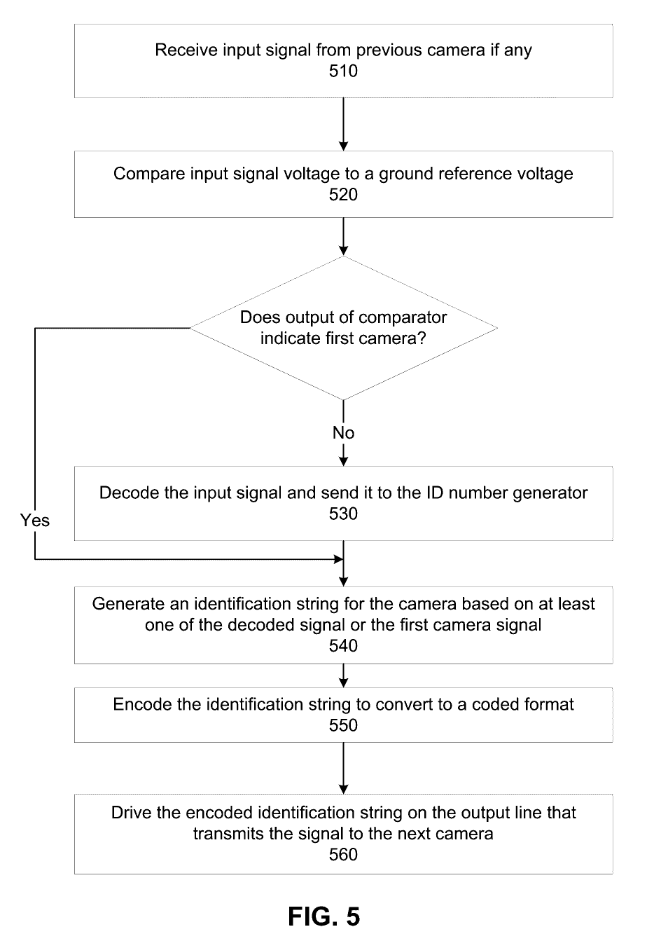

FIG. 5 illustrates a flowchart for a method of enumerating each camera in an array of cameras connected in a daisy chain, according to an example embodiment. The enumeration circuit connected to the camera 120 receives 510 an input signal 205 from the previous camera, if there is one. The input signal 205 voltage is compared to a ground reference voltage by a comparator. If the comparator output indicates it's not a first device, the input signal 205 is decoded 530 to determine the identification string of the previous device. If the comparator output indicates it's a first device, the decoding of input signal is skipped. Once the input signal is decoded or it is determined that the device is a first device, an identification string is generated 540 based on an algorithm that uses at least one of the decoded input signal or the first camera signal. The first camera signal determines if the device is a first device or not. The identification string is serially encoded 550 to convert it to a coded format. The encoded identification string is driven 560 on the output line by a line driver, the output line is connected to the input line of the next camera.

### Example Camera Architecture

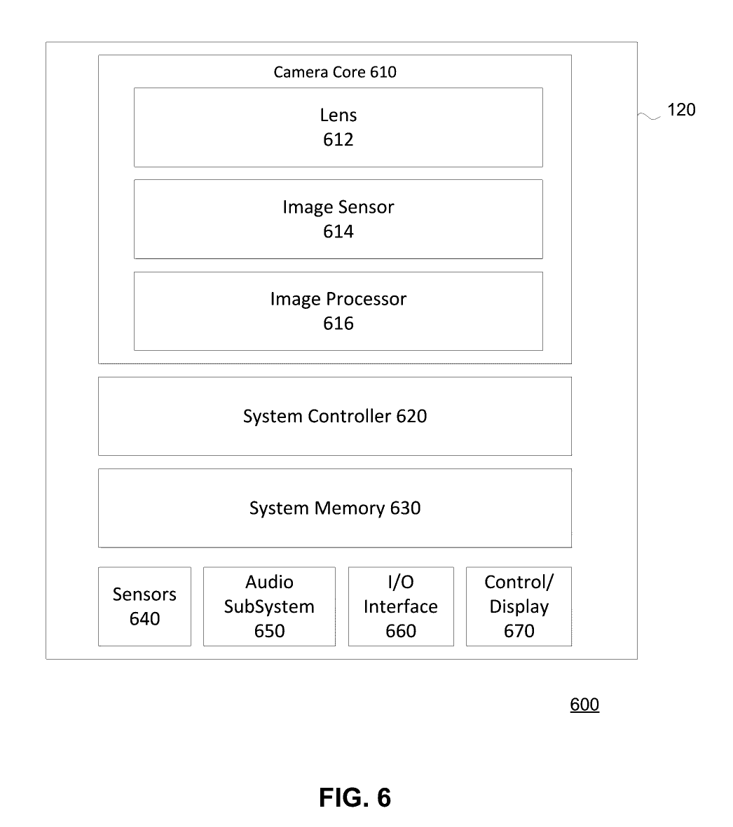

FIG. 6 illustrates a block diagram of an exemplary camera architecture 600. The camera architecture 605 corresponds to an architecture for the camera, e.g., 120. In one embodiment, the camera 120 is capable of capturing spherical or substantially spherical content. As used herein, spherical content may include still images or video having spherical or substantially spherical field of view. For example, in one embodiment, the camera 120 captures video having a 360° field of view in the horizontal plane and a 180° field of view in the vertical plane. Alternatively, the camera 120 may capture substantially spherical images or video having less than 360° in the horizontal direction and less than 180° in the vertical direction (e.g., within 10% of the field of view associated with fully spherical content). In other embodiments, the camera 120 may capture images or video having a non-spherical wide angle field of view.

As described in greater detail below, the camera 120 can include sensors 940 to capture metadata associated with video data, such as timing data, motion data, speed data, acceleration data, altitude data, GPS data, and the like. In a particular embodiment, location and/or time centric metadata (geographic location, time, speed, etc.) can be incorporated into a media file together with the captured content in order to track the location of the camera 120 over time. This metadata may be captured by the camera 120 itself or by another device (e.g., a mobile phone) communicatively coupled with the camera 120. In one embodiment, the metadata may be incorporated with the content stream by the camera 120 as the spherical content is being captured. In another embodiment, a metadata file separate from the video file may be captured (by the same capture device or a different capture device) and the two separate files can be combined or otherwise processed together in post-processing. It is noted that these sensors 640 can be in addition to other sensors.

In the embodiment illustrated in FIG. 6, the camera 120 comprises a camera core 610 comprising a lens 612, an image sensor 614, and an image processor 616. The camera 120 additionally includes a system controller 620 (e.g., a microcontroller or microprocessor) that controls the operation and functionality of the camera 120 and system memory 630 configured to store executable computer instructions that, when executed by the system controller 620 and/or the image processors 616, perform the camera functionalities described herein. In some embodiments, a camera 120 may include multiple camera cores 610 to capture fields of view in different directions which may then be stitched together to form a cohesive image.

The lens 612 can be, for example, a wide angle lens, hemispherical, or hyper hemispherical lens that focuses light entering the lens to the image sensor 614 which captures images and/or video frames. The image sensor 614 may capture high-definition images having a resolution of, for example, 720p, 1080p, 4k, or higher. In one embodiment, spherical video is captured in a resolution of 5760 pixels by 2880 pixels with a 360° horizontal field of view and a 180° vertical field of view. For video, the image sensor 614 may capture video at frame rates of, for example, 30 frames per second, 60 frames per second, or higher. The image processor 616 performs one or more image processing functions of the captured images or video. For example, the image processor 616 may perform a Bayer transformation, demosaicing, noise reduction, image sharpening, image stabilization, rolling shutter artifact reduction, color space conversion, compression, or other in-camera processing functions. Processed images and video may be temporarily or persistently stored to system memory 630 and/or to a non-volatile storage, which may be in the form of internal storage or an external memory card.

An input/output (I/O) interface 660 transmits and receives data from various external devices. For example, the I/O interface 660 may facilitate the receiving or transmitting video or audio information through an I/O port. Examples of I/O ports or interfaces include USB ports, HDMI ports, Ethernet ports, audio ports, and the like. Furthermore, embodiments of the I/O interface 660 may include wireless ports that can accommodate wireless connections. Examples of wireless ports include Bluetooth, Wireless USB, Near Field Communication (NFC), and the like. The I/O interface 660 may also include an interface to synchronize the camera 120 with other cameras or with other external devices, such as a remote control, a second camera, a smartphone, a client device, or a video server.

A control/display subsystem 670 includes various control and display components associated with operation of the camera 120 including, for example, LED lights, a display, buttons, microphones, speakers, and the like. The audio subsystem 650 includes, for example, one or more microphones and one or more audio processors to capture and process audio data correlated with video capture. In one embodiment, the audio subsystem 650 includes a microphone array having two or microphones arranged to obtain directional audio signals.

Sensors 640 capture various metadata concurrently with, or separately from, video capture. For example, the sensors 640 may capture time-stamped location information based on a global positioning system (GPS) sensor, and/or an altimeter. Sensor data captured from the various sensors 640 may be processed to generate other types of metadata. For example, sensor data from the accelerometer may be used to generate motion metadata, comprising velocity and/or acceleration vectors representative of motion of the camera 120. In one embodiment, the sensors 640 are rigidly coupled to the camera 120 such that any motion, orientation or change in location experienced by the camera 120 is also experienced by the sensors 640. The sensors 640 furthermore may associates a time stamp representing when the data was captured by each sensor. In one embodiment, the sensors 640 automatically begin collecting sensor metadata when the camera 120 begins recording a video.

The camera 120 can be enclosed within a camera mounting structure 300/400, such as the one depicted in FIGS. 3 and 4. The camera mounting structure 300/400 can include electronic connectors which can couple with the corresponding camera (not shown) when a power and/or communication source is incorporated into the camera mounting structure 300/400.

### Additional Considerations

Example benefits and advantages of the disclosed configurations include automatic enumeration of devices. The method of manual enumeration is prone to errors such as incorrect order of identification strings resulting in incorrect stitching of images from the devices. Additionally, if a device requires replacement, the identification string needs to be re-assigned as well which may be prone to human error. The automated method of enumeration of devices overcomes these and other problems that result in errors caused by a manual assignment of identification of devices. Additionally, the process of enumerating a device that replaces a faulty device in the array is convenient using the automated enumeration method. Once devices are properly enumerated a system of device, e.g. cameras 120 can be configured to capture a plurality of images and generate a single image comprised on individual captured images from each camera 120 in the system of enumerated cameras. The single image can be, for example, a 360 degree planar view or full spherical view depending on the orientation of the cameras of the system.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate the system and method of enumeration of cameras in an array. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An apparatus comprising an enumeration circuit for enumerating devices in an array, the enumeration circuit comprising:
an input line to receive an input signal;
a comparator comprising of a first input terminal connected to the input line and a second input terminal connected to a ground reference, wherein the comparator compares a voltage of the input signal to a voltage of the ground reference;
a first device detector module coupled to the input comparator and comprising of a first input terminal connected to the input line and a second input terminal connected to an output of the comparator, wherein the first device detector module determines a first device and performs at least one of an assertion or de-assertion of a first camera signal;
a serial decoder module connected to the input signal wherein the serial decoder module decodes the input signal to determine an identification string of a previous device;
an identification number generator coupled to an output of the serial decoder and the first camera signal from the first device detector module wherein the identification number generator generates an identification string for a current device;
a serial encoder module connected to an output of the identification number generator wherein the serial encoder encodes the identification string; and
a line driver connected to an output of the serial encoder module wherein the line driver drives the encoded identification string on an output line to transmit it to a second device of the plurality of devices.

2. The apparatus of claim 1, wherein the input signal is a received encoded identification string.

3. The apparatus of claim 1, wherein a current source is connected to an output line to maintain a continuous voltage level when there is no data on the output line.

4. The apparatus of claim 1, wherein the input line is further connected to a resistor in parallel that causes the input signal to be at the ground reference voltage level in the absence of receiving an input signal from a previous device of the plurality of devices.

5. A computer readable medium configured to store instructions, the instructions when executed by a processor cause the processor to:
receive an input signal on an input line;
compare the input signal to a ground reference;
generate, responsive to comparing the input signal to the ground reference that the camera is a first device of a plurality of devices, a first identification string for the first device;
decode, responsive to comparing the input signal to the ground reference that the camera is not a first device, the input signal and generate an identification string for the device based on the decoded input signal;
encode the identification string; and
drive the encoded identification string on an output line to transmit it to a second device of the plurality of devices.

6. The computer readable storage medium of claim 5, wherein the input signal is a received encoded identification string.

7. The computer readable storage medium of claim 5, wherein two or more devices are connected in a daisy chain.

8. The computer readable storage medium of claim 5, wherein the identification string for a first device is different from the identification string for a second device.

9. The computer readable storage medium of claim 5, wherein the identification string for a device is a combination of previous device and current device identification strings.

10. The computer readable storage medium of claim 5, wherein a current source is connected to an output line to maintain a continuous voltage level when there is no data on the output line.

11. The computer readable storage medium of claim 5, wherein encoding further comprises of converting the identification string to a serial coded format.

12. The computer readable storage medium of claim 5, wherein the comparing the input signal further comprises of detecting a voltage difference between the input signal and a ground reference voltage.

13. The computer readable storage medium of claim 5, wherein the input line is further connected to a resistor in parallel that causes the input signal to be at the ground reference voltage level in the absence of an input signal from a previous device.

14. A computer-implemented method for enumerating a plurality of devices in an array, the method comprising:
receiving an input signal on an input line;
comparing the input signal to a ground reference;
generating, responsive to comparing the input signal to the ground reference that a camera is a first device of a plurality of devices, a first identification string for the first device;
decoding, responsive to comparing the input signal to the ground reference that the camera is not a first device, the input signal and generating an identification string for the device based on the decoded input signal;
encoding the identification string; and
driving the encoded identification string on an output line to transmit it to a second device of the plurality of devices.

15. The method of claim 1, wherein the input signal is a received encoded identification string.

16. The method of claim 15, wherein the plurality of devices are connected in a daisy chain.

17. The method of claim 15, wherein the identification string for a first device is different from the identification string for a second device.

18. The method of claim 15, wherein the identification string for a device is a combination of previous device and current device identification strings.

19. The method of claim 15, wherein a current source is connected to an output line to maintain a continuous voltage level when there is no data on the output line.

20. The method of claim 15, wherein encoding further comprises of converting the identification string to a serial coded format.

21. The method of claim 15, wherein the comparing the input signal further comprises detecting a voltage difference between the input signal and a ground reference voltage.

22. The method of claim 15, wherein the input line is further connected to a resistor in parallel that causes the input signal to be at the ground reference voltage level in the absence of receiving an input signal from a previous device.
